(19) United States
(12) Patent Application Publication
(10) Pub. No.: US 2013/0240583 A1
(43) Pub. Date: Sep. 19, 2013

(54) SET OF CONTAINERS AND A METHOD OF CAR BODY REINFORCEMENT

(71) Applicants: Alicia Langsteiner, Ostrusza (PL); Gerhard Michael Mikolaiczik, Rothenbach an der Pegnitz (DE); Albert Stanislaw Wojtowicz, Gorlice (PL)

(72) Inventors: Alicia Langsteiner, Ostrusza (PL); Gerhard Michael Mikolaiczik, Rothenbach an der Pegnitz (DE); Albert Stanislaw Wojtowicz, Gorlice (PL)

(73) Assignee: ALICJA LANGSTEINER, Ostrusza (PL)

(21) Appl. No.: 13/988,159

(22) PCT Filed: Nov. 16, 2011
(86) PCT No.: PCT/PL2011/000118

§ 371 Date: May 17, 2013

(30) Foreign Application Priority Data
Nov. 23, 2010 (PL) P-393027

(51) Int. Cl. B60R 5/04

(52) U.S. Cl. CPC B60R 5/04
USPC 224/311; 29/897

(57) ABSTRACT

A set of containers comprising containers made of materials able to transfer collision forces, when the car body is hit, where the containers are shaped in relation to each other and in relation to the surfaces limiting the car boot space in such a way that they fill this space completely. The invention refers also to the method of car body reinforcement by filling the car boot with the containers shaped in relation to each other and in relation to the surfaces limiting the car boot space in such a way that they fill this space completely.

### TECHNICAL FIELD

The object of the present invention is a set of containers intended for reinforcement of a car body, and a method of car body reinforcement, in particular automobiles.

### BACKGROUND ART

Most of the cars have so called crumple zones located in the front part of the car. The role of crumple zones is to absorb the kinetic energy. Their use enhances the passive safety of the car, in particular in case of front collisions. The rear part of the car is usually the weakest part of the car structure. It is particularly dangerous in case of car accidents when the rear and side-rear part of the car is hit. Empty space of the car boot is not able to absorb the energy created during collision. Additionally luggage placed in the boot may, in case of side or rear collision, act as bullets causing additional harm to passengers being in the cabin of the car.

Patent specification No. DE10009508 discloses the set of suitcases adjusted to the side walls of the boot. The suitcases being the part of the set are made of aluminum or/and plastics. The aim of this invention is to provide the adequate filling of the boot, but it has no influence with regard to safety.

In order to protect the passengers against side-collision or rear collision impact the car body is reinforced by use of longitudinal beams or strengthening of car body side sills. But this type of reinforcement is not completely satisfactory, and above all must constitute the element of the car body at the very beginning. So it is not possible to use such reinforcements in older car models.

### DISCLOSURE OF THE INVENTION

The idea of the invention consists in such stiffening of the rear part of the car, without reduction of its utility values, and without generating additional weight of the car body, that the car body is reinforced, what improves safety of passengers in case of rear and side car collisions.

A set of containers, used for reinforcement of car body according to the invention comprises containers made of materials able to transfer collision forces, when the car body is hit, where the containers are shaped in relation to each other and in relation to the surfaces limiting the car boot space in such a way that they fill this space completely. As the each of the containers included in the set is shaped in such a way that it fits the walls and bottom of the boot, and all the containers put together fill the space of the boot not leaving free spaces, the containers do not move in the boot, and create homogenous structure in the boot, which in case of side collision transfers forces, enabling conversion of kinetic energy into energy of rotation around the vertical axis of the vehicle (energy dissipation by tires friction forces), and in case of rear collision absorbs created kinetic energy. Therefore the choice of the materials used for making the containers is very important. The term “made of materials” means both the cases when the whole container is made of materials meeting specified resistance parameters, and the cases when the suitcase framing, i.e. the element of the suitcase determining its strength, is made of materials meeting specified resistance parameters, and the rest of elements is made of other materials usually used for making such type of containers.

Preferably the external walls of the containers are made of materials having tensile strength at the limit of plasticity equal or higher than 20 MPa.

Preferably the external walls of the containers are made of materials having compression strength at the limit of plasticity equal or higher than 65 MPa.

Preferably the external walls of the containers are made of materials having Young's module equal or higher than 1500 MPa.

Preferably the external walls of the containers have thickness equal or higher than 2 mm.

Preferably the external walls of the containers are made of polycarbonate or/and polypropylene or/and Kevlar or/and ABS (acrylonitrile butadiene styrene). It is also possible to use other materials having similar resistance parameters.

Preferably the containers are suitcases.

Preferably the suitcases have recesses in their walls, strictly speaking these are pits enabling the suitcases to adhere closely to each other. Additionally the suitcases have biaxially hinged cover or/and flattened bottom or/and flattened cover or/and anti-skidding pads on the external wall of the bottom or/and cover. Thanks to biaxially hinged covers the suitcases adhere closely to each other. Flattened bottom or/and cover enables the suitcase to adhere closely to the bottom of the boot. Anti-skidding pads prevent the suitcases from moving inside the car boot. Additionally such shape of the suitcases enables optimal transfer of forces from one suitcase to another.

Preferably the edges of side walls of upper and lower part of the suitcase being in contact with each other, when the suitcase is closed, are not parallel to the bottom of the suitcase, and as a result the hinges of the suitcase are not positioned at the same height as the closure of the suitcase. Such position of the suitcase closure in relation to the hinges results in enhancement of the surface of contact between the suitcases, and thanks to that the suitcases better adhere to each other, and better fill the space of the car boot.

A method of car body reinforcement according to the present invention, consists in that the car boot is filled with containers made of materials able to transfer collision forces, when the car body is hit, where the containers are shaped in relation to each other and in relation to the surfaces limiting the car boot space in such a way that they fill this space completely. The term “made of materials” means either that the whole container is made of materials meeting specified resistance parameters, or that the suitcase framing, i.e. the element of the suitcase determining its strength, is made of materials meeting specified resistance parameters, and the rest of elements is made of other materials usually used for making of such type of containers.

Preferably the containers have external walls made of materials having tensile strength at the limit of plasticity equal or higher than 20 MPa.

Preferably the containers have external walls made of materials having compression strength at the limit of plasticity equal or higher than 65 MPa.

Preferably the containers have external walls made of materials having Young's module equal or higher than 1500 MPa.

Preferably the containers have external walls having thickness equal or higher than 2 mm.

Preferably the containers have external walls made of polycarbonate or/and polypropylene or/and Kevlar or/and ABS (acrylonitrile butadiene styrene). It is also possible to use other materials having similar resistance parameters. Preferably the containers are suitcases.

Preferably the suitcases have recesses in their walls. Preferably the suitcases have biaxially hinged cover or/and flattened bottom or/and flattened cover or/and anti-skidding pads on the external wall of the bottom or/and cover.

Preferably the edges of side walls of upper and lower part of the suitcase being in contact with each other, when the suitcase is closed, are not parallel to the bottom of the suitcase, and as a result the hinges of the suitcase are not positioned at the same height as the closure of the suitcase.

Use of the invention consists in filling of the whole space of the car boot with suitcases fitting to each other, and having stiff construction, in such a way that they create a honeycomb structure. The task of this structure is to transfer forces created as a result of car collision as follows:

in case of side rear collision (force—slantly from the front to the back) the collision will have the character close to elastic, what will result in conversion of smaller amount of kinetic energy into energy of deformation, because instead of jamming, the vehicle will rotate around its vertical axis, what in comparison to inelastic collision (bigger deformation of car body, and jamming of vehicles) will reduce the forces impacting the passengers—hitting car still conserves part of kinetic energy;

in case of rear collision (along the roll axis of the vehicle, and at an angle to it) the collision has character of inelastic collision, and the kinetic energy to bigger extent is converted into energy of deformation of car body elements, elements that do not take part in the collision (space frame created by suitcases transfers forces to side parts of car body and to wheel arches);

in case of front collisions all travellers' articles are in suitcases, that kept by the back rest of the back seat, and by the cover of the car boot will not fly to the front of the car, and hit the passenger.

In order to achieve desired reinforcement of the car body it is necessary to fill the space of the car boot entirely with suitcase that are shaped in such a way to fit each other, and placed in a way allowing for maximal transfer of forces by the structure of each suitcase. Therefore the suitcase must have shapes adapted to the form of the car boot. The suitcases should be made of stiff materials in order to ensure desired transfer of forces. As a result:

the elements of luggage are used to improve the passive safety of passengers;

additional stiffening element is introduced, being a set of suitcases;

luggage fills the space of the car boot entirely, and as a result it may better transfer forces impacting the elements of car body;

deflection of car body during collision is reduced thanks to enhanced stiffness of the car structure;

the way of energy conversion from kinetic to energy of deformation is changed advantageously or the amount of kinetic energy created during collision is reduced;

the forces impacting the passengers during the side rear collision are reduced, because the collision closer to elastic collision with centre of gravity of the car results in smaller change of velocity vector of passengers. In accordance with energy conservation law force integral (impacting passengers) is reduced over time, what means decrease of danger for health of passengers during the collision.

### BEST MODE OF CARRYING OUT THE INVENTION

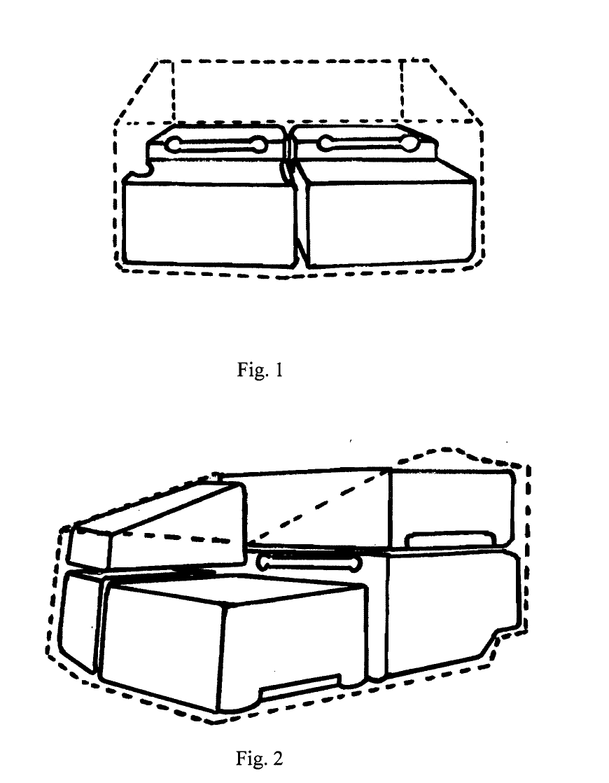

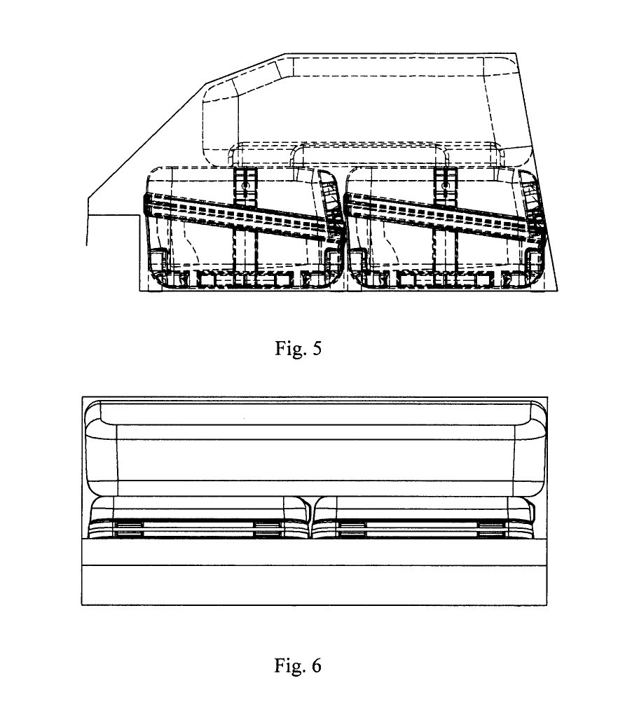

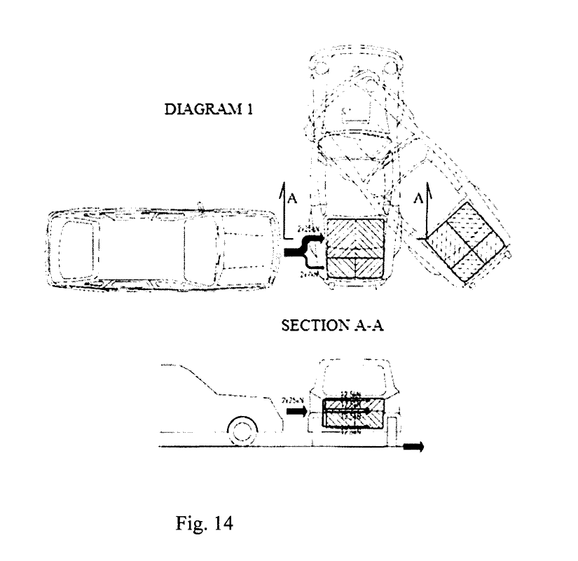

The following examples illustrate the invention without setting or delineating its limits. FIGS. 1, 2 and 3 illustrate the set of containers placed in the car boot, FIG. 4—the set of containers adapted to the shape of the car boot, FIG. 5, 6, 7—set of containers filling the car boot, FIG. from 8 to 13—a suitcase being a part of the set, and FIG. 14 illustrates distribution of forces during collision in the car boot filled with the set of containers in accordance with the present invention.

### EXAMPLE 1

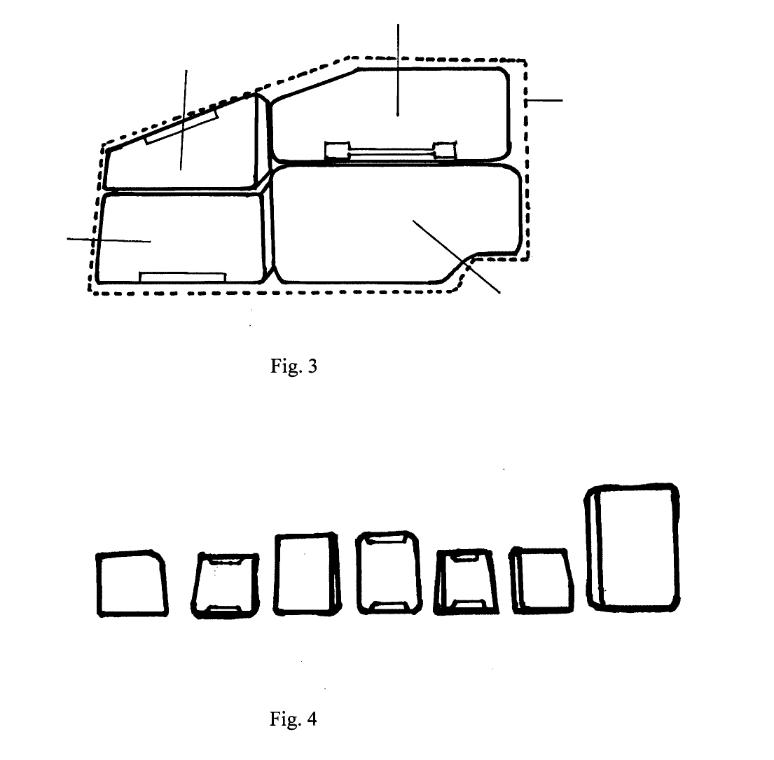

Containers 2, 3, 4 and 5 are placed in the car boot 1. The containers are adapted to the shape of side walls, and the bottom of the car boot as shown at FIG. 1. Then the containers 6 and 7 adapted to the shape of the car boot walls and the shelve and cover of the car boot are placed on top, as shown at FIG. 2. At the end container 8 is placed in the car boot as shown at FIG. 3. All the containers filling the car boot are shaped in such a way to adhere to each other, and to adhere to the walls of the car boot, as a result the car boot is entirely filled with the containers. The set of containers is shown at 4. All containers were made of polycarbonate. Thickness of the walls of containers is 2 mm.

### EXAMPLE 2

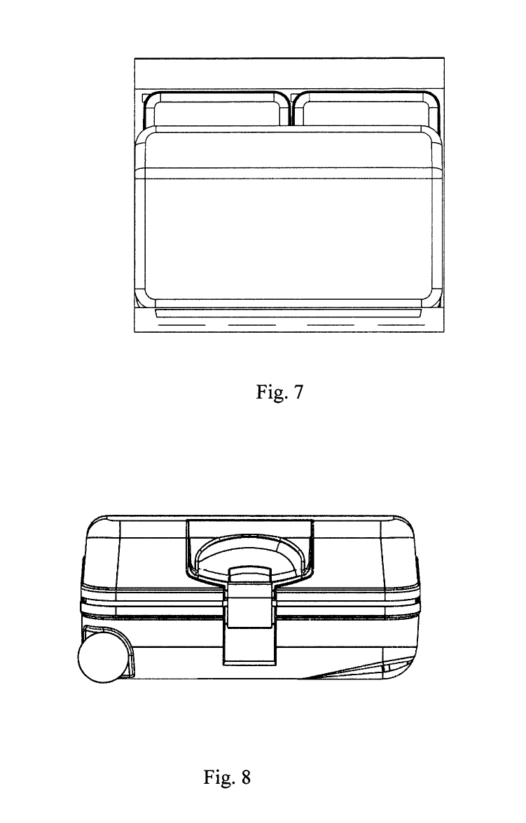

In this example the car boot is filled with suitcase, as shown at FIG. 5, which shows the side view of the car boot, at FIG. 6, which shows the front view of the car boot, and at FIG. 7 showing the top view of the car boot.

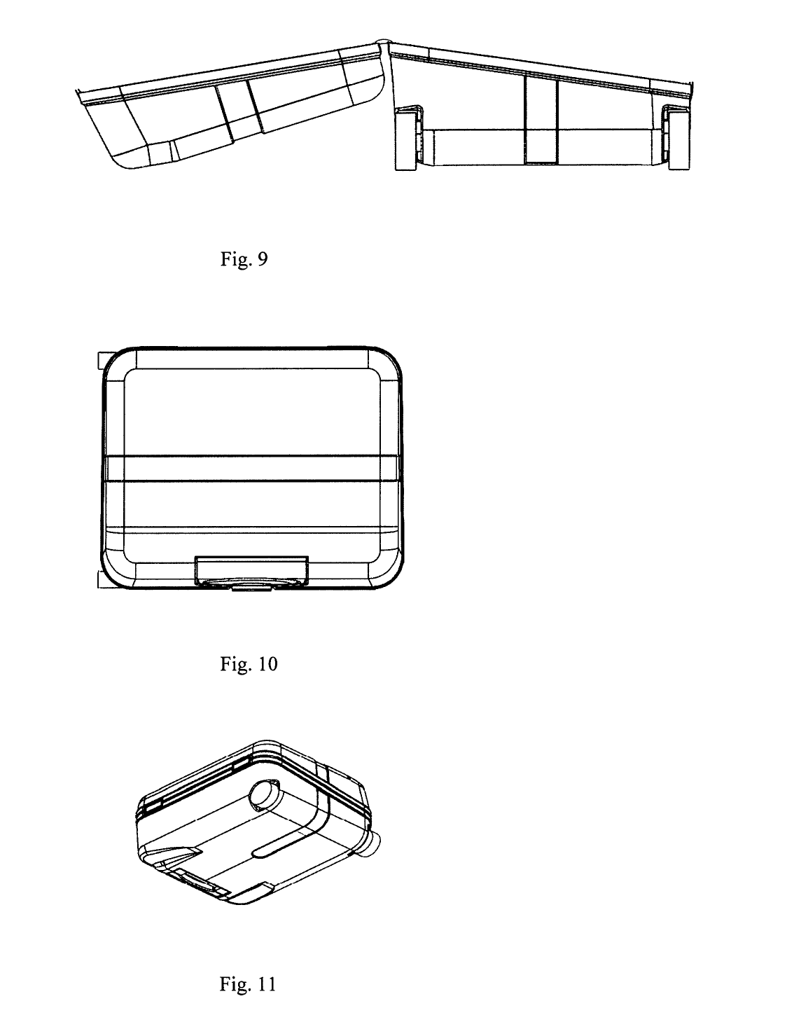

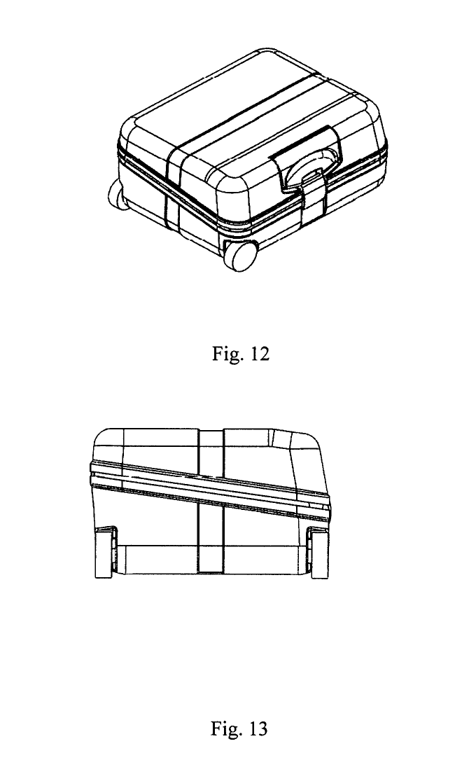

As it is shown at FIG. 8, suitcase 9 has recesses 10 in its side walls enhancing the surface of contact between the suitcases. As it is shown at FIG. 9 suitcase 9 has biaxial hinges 11. Additionally bottom of the suitcase 12 and cover of the suitcase 13 have flattened surfaces in order to enhance the surface contact with the bottom of the car boot. As it is shown at FIG. 10 cover of the suitcase 13 has anti-skidding pad 14 made of silicon. Similarly, as shown at FIG. 11, the bottom of the suitcase 12 has anti-skidding pad 14 made of silicon. As it is shown at FIG. 12 and FIG. 13, the surface of contact between the upper and the lower part of the suitcase 15 are position at acute angle in relation to the bottom of the suitcase 12, and as a result the hinges of the suitcase 11 are not positioned at the same height with the closure of the suitcase 16. The suitcase are made of polycarbonate. Thickness of the walls of suitcases is 4 mm.

In order to confirm the effectiveness of the invention the tests were carried out. The containers used during the tests were made of polycarbonate, and the thickness of their walls was 4 mm. The containers were adapted to the shape of the car boot and were adhering to each other.

FIG. 14 shows the situation when the car is hit in the car boot perpendicularly to the roll axis of the car. The car is moving or parking. The forces illustrated at the FIG. 14 are terminal forces that may be transferred by the set of the containers. In case of the collision with the car having average mass, moving with the speed of 60 km/h, the active force will be much higher than the total resistance of the containers. Part of the energy created during the collision will be initially absorbed by the car body, which after deformation at the side of the collision will transfer forces on the set of containers. Stiffness of the containers together with the adhering to them construction of the car boot will transfer the energy to the rear axis of the vehicle, and will cause its rotation. Rotation of the vehicle takes place at the moment when the forces of adhesion between the tires and the pavement are exceeded. The size of the force depends on the mass of the vehicle, the kind, and the humidity of the pavement, and on the fact whether the vehicle is moving or being standstill. The vehicle having weight per axle of 800 kg, being standstill needs horizontal force per axle of 1.6kN-6.5kN to loss of adherence and start of rotation, depending on the kind of pavement (asphalt, concrete) and its humidity (wet, dry). These are the forces significantly lower than the forces transferred by the containers. The stiffness of containers and their co-operation with elements of car body—by rotation of the vehicle—allows for significant reduction of the effects of the collision both for the passengers and the vehicle.

1. A set of containers, characterised in that, it comprises containers made of materials able to transfer collision forces, when the car body is hit, where the containers are shaped in relation to each other and in relation to the surfaces limiting the car boot space in such a way that they fill this space completely.

2. The set according to claim 1, characterised in that, the external walls of the containers are made of materials having tensile strength at the limit of plasticity equal or higher than 20 MPa.

3. The set according to claim 1, characterised in that the external walls of the containers are made of materials having compression strength at the limit of plasticity equal or higher than 65 MPa.

4. The set according to claim 1, characterised in that the external walls of the containers are made of materials having Young's module equal or higher than 1500 MPa.

5. The set according to claim 1, characterised in that the external walls of the containers have thickness equal or higher than 2 mm.

6. The set according to claim 1, characterised in that, the external walls of the containers are made of polycarbonate or/and polypropylene or/and Kevlar or/and ABS (acrylonitrile butadiene styrene).

7. The set according to claim 1, characterised in that the containers are suitcases.

8. The set according to claim 7, characterised in that the suitcases have recesses in their walls (10).

9. The set according to claim 7, characterised in that the suitcases have biaxially hinged cover (11) or/and flattened bottom or/and flattened cover or/and anti-skidding pads (14) on the external wall of the bottom or/and cover.

10. The set according to claim 7, characterised in that the edges of side walls of upper and lower part of the suitcase (15) being in contact with each other, when the suitcase is closed, are not parallel to the bottom of the suitcase, and as a result the hinges of the suitcase (11) are not positioned at the same height as the closure of the suitcase (16).

11. A method of car body reinforcement, characterised in that the car boot is filled with containers made of materials able to transfer collision forces, when the car body is hit, where the containers are shaped in relation to each other and in relation to the surfaces limiting the car boot space in such a way that they fill this space completely.

12. The method according to claim 11, characterised in that the containers have external walls made of materials having tensile strength at the limit of plasticity equal or higher than 20 MPa.

13. The method according to claim 11, characterised in that the containers have external walls made of materials having compression strength at the limit of plasticity equal or higher than 65 MPa.

14. The method according to claim 11, characterised in that the containers have external walls made of materials having Young's module equal or higher than 1500 MPa.

15. The method according to claim 11, characterised in that the containers have external walls having thickness equal or higher than 2 mm.

16. The method according to claim 12, characterised in that the containers have external walls made of polycarbonate or/and polypropylene or/and Kevlar or/and ABS (acrylonitrile butadiene styrene).

17. The method according to claim 11, characterised in that the containers are suitcases.

18. The method according to claim 17, characterised in that the suitcases have recesses in their walls (10).

19. The method according to claim 17, characterised in that the suitcases have biaxially hinged cover (11) or/and flattened bottom or/and flattened cover or/and anti-skidding pads (14) on the external wall of the bottom or/and cover.

20. The method according to claim 17, characterised in that the edges of side walls of upper and lower part of the suitcase (15) being in contact with each other, when the suitcase is closed, are not parallel to the bottom of the suitcase, and as a result the hinges of the suitcase (11) are not positioned at the same height as the closure of the suitcase (16).
